(19) United States
(12) Patent Application Publication
(10) Pub. No.: US 2024/0056778 A1
(43) Pub. Date: Feb. 15, 2024

(54) NEXT GENERATION CONVERGED MESSAGING

(71) Applicant: T-Mobile Innovations LLC, Overland Park, KS (US)

(72) Inventors: Chingming CHAO, Bellevue, WA (US); Sean Patrick HOELZLE, Collegeville, PA (US)

(21) Appl. No.: 17/886,234

(22) Filed: Aug. 11, 2022

(51) Int. Cl. H04W 4/12

(52) U.S. Cl. CPC H04W 4/12

(57) ABSTRACT

Systems and methods for providing converged message services corresponding to one or more messages via a telecommunication network include a cell site, a storage system, a control plane, and a central message system including one or more converged message services communicatively coupled to the cell site, control plane, and the storage system. The central message system to provide, via the one or more converged message services based on a set of containers in a cluster, one or more first messages, and receive one or more secondary messages, the one or more first messages and the one or more secondary messages corresponding to at least one of a short message service (SMS), multi-media service (MMS), or rich communication service (RCS).

### SUMMARY

The present disclosure is directed, in part, to providing converged message services corresponding to one or more messages via a telecommunication network, substantially as shown in and/or described in connection with at least one of the figures, and as set forth more completely in the claims.

In aspects set forth herein, a message (e.g., a short message service (SMS) or multi-media service (MMS)) between user devices flows through telecom messaging architecture. Typically, each message function is defined as a single service node. Each service node is separate such that the message flows through individual service nodes which increases the length of the message delivery time. However, here, a central message system includes one or more converged message services that provides one or more first messages and receives one or more secondary messages, which reduces the length of message delivery time and simplifies delivery.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE SEVERAL VIEWS OF THE DRAWINGS

Illustrative embodiments of the present invention are described in detail below with reference to the attached drawing figures, and wherein:

FIG. 1 depicts an example of a network environment in accordance with one or more embodiments;

FIG. 2 is a diagram of a network environment including a central message system in accordance with an example embodiment;

FIG. 3 depicts a flowchart of an exemplary method for providing converged message services corresponding to one or more messages via a telecommunication network in accordance with an example embodiment; and

FIG. 4 depicts an exemplary computing device suitable for use in implementations of aspects herein.

### DETAILED DESCRIPTION

The subject matter of embodiments of the invention is described with specificity herein to meet statutory requirements. However, the description itself is not intended to limit the scope of this patent. The claimed subject matter might be embodied in other ways to include different steps or combinations of steps similar to the ones described in this document, in conjunction with other present or future technologies. Terms should not be interpreted as implying any particular order among or between various steps herein disclosed unless and except when the order of individual steps is explicitly described.

In certain aspects, methods are provided for providing converged message services corresponding to one or more messages via a telecommunication network. One or more first messages are provided. Based on the one or more first messages, one or more secondary messages are received, the one or more first messages and the one or more secondary messages corresponding to at least one of a short message service (SMS), multi-media service (MMS), or rich communication service (RCS).

Advantageously, providing converged message services corresponding to one or more messages provides a converged service system that reduces the length of message delivery time.

In one aspect, a system is provided for providing converged message services corresponding to one or more messages via a telecommunication network. The system includes a cell site, a storage system, a control plane, and a central message system including one or more converged message services communicatively coupled to the cell site, control plane, and the storage system. The central message system provides, via the one or more converged message services based on a set of containers in a cluster, one or more first messages. The central message system also receives one or more secondary messages. The one or more first messages and the one or more secondary messages corresponding to at least one of a short message service (SMS), multi-media service (MMS), or rich communication service (RCS).

In another aspect, a computer-readable storage media having computer-executable instructions embodied thereon is provided that, when executed by one or more processors cause the processors to perform various steps. The processors are caused to provide, via a central message system including a message storage service, one or more first messages, wherein the message storage service stores the one or more first messages. The processors are also caused to, based on the one or more first messages, receive one or more secondary messages. The one or more first messages and the one or more secondary messages corresponding to at least one of a short message service (SMS), multi-media service (MMS), or rich communication service (RCS).

In yet another aspect, a method is provided for providing converged message services corresponding to one or more messages via a telecommunication network. The method includes providing, via one or more converged message services communicatively coupled to a cell site, control plane, and storage system, one or more first messages. The method also includes receiving one or more secondary messages. The one or more first messages and the one or more secondary messages corresponding to at least one of a short message service (SMS), multi-media service (MMS), or rich communication service (RCS).

Throughout this disclosure, several acronyms and shorthand notations are used to aid the understanding of certain concepts pertaining to the associated system and methods. These acronyms and shorthand notations are intended to help provide an easy methodology of communicating the ideas expressed herein and are not meant to limit the scope of aspects herein.

Embodiments herein may be embodied as, among other things: a method, system, or set of instructions embodied on one or more computer-readable media. Computer-readable media include both volatile and nonvolatile media, removable and non-removable media, and contemplate media readable by a database, a switch, and various other network devices. Computer-readable media includes media implemented in any way for storing information. Examples of stored information include computer-useable instructions, data structures, program circuitry, and other data representations. Media examples include RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These technologies can store data momentarily, temporarily, or permanently. Embodiments may take the form of a hardware embodiment, or an embodiment combining software and hardware. Some embodiments may take the form of a computer-program product that includes computer-useable or computer-executable instructions embodied on one or more computer-readable media.

“Computer-readable media” may be any available media and may include volatile and nonvolatile media, as well as removable and non-removable media. By way of example, and not limitation, computer-readable media may include computer storage media and communication media.

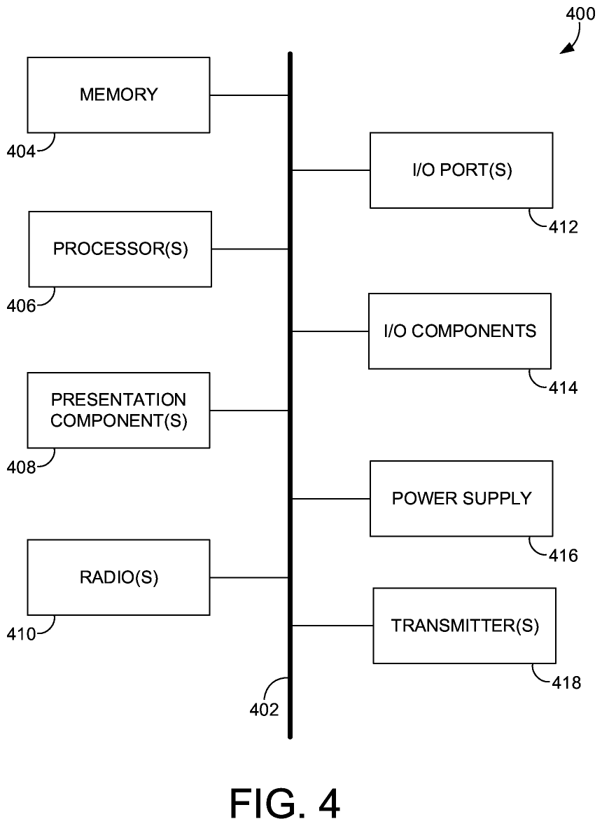

“Computer storage media” may include, without limitation, volatile and nonvolatile media, as well as removable and non-removable media, implemented in any method or technology for storage of information, such as computer-readable instructions, data structures, program circuitry, or other data. In this regard, computer storage media may include, but is not limited to, Random Access Memory (RAM), Read-Only Memory (ROM), Electrically Erasable Programmable Read-Only Memory (EEPROM), flash memory or other memory technology, CD-ROM, digital versatile disks (DVDs) or other optical disk storage, magnetic cassettes, magnetic tape, magnetic disk storage, or other magnetic storage devices, or any other medium which may be used to store the desired information and which may be accessed by the computing device 400 shown in FIG. 4. Computer storage media does not comprise a signal per se.

“Communication media” may include, without limitation, computer-readable instructions, data structures, program circuitry, or other data in a modulated data signal, such as a carrier wave or other transport mechanism, and may include any information delivery media. As used herein, the term “modulated data signal” refers to a signal that has one or more of its attributes set or changed in such a manner as to encode information in the signal. By way of example, and not limitation, communication media includes wired media such as a wired network or direct-wired connection, and wireless media such as acoustic, radio frequency (RF), infrared, and other wireless media. Combinations of any of the above also may be included within the scope of computer-readable media.

The terms “user equipment,” “UE,” “provider device,” “receiver device,” and “user device” are used interchangeably to refer to a device employed by an end-user that communicates using a network. UE generally includes one or more antenna coupled to a radio for exchanging (e.g., transmitting and receiving) transmissions with a nearby base station, via an antenna array of the base station. In embodiments, the UE may take on any variety of devices, such as a personal computer, laptop computer, tablet, netbook, mobile phone, smart phone, personal digital assistant, wearable device, augmented reality device, fitness tracker, or any other device capable of communicating using one or more resources of the network. The UE may include components such as software and hardware, a processor, a memory, a display component, a power supply or power source, a speaker, a touch-input component, a keyboard, and the like. In embodiments, some of the UE discussed herein may include current UE capable of using 5G or 6G and having backward compatibility with prior access technologies, current UE capable of using 5G or 6G and lacking backward compatibility with prior access technologies, and legacy UE that is not capable of using 5G or 6G.

A “network” refers to a network comprised of wireless and wired components that provide wireless communications service coverage to one or more UE. The network may comprise one or more base stations, one or more cell sites (i.e., managed by a base station), one or more cell towers (i.e., having an antenna) associated with each base station or cell site, a gateway, a backhaul server that connects two or more base stations, a database, a power supply, sensors, and other components not discussed herein, in various embodiments.

The terms “base station” and “cell site” may be used interchangeably herein to refer to a defined wireless communications coverage area (i.e., a geographic area) serviced by a base station. It will be understood that one base station may control one cell site or alternatively, one base station may control multiple cell sites. As discussed herein, a base station is deployed in the network to control and facilitate, via one or more antenna arrays, the broadcast, transmission, synchronization, and receipt of one or more wireless signals in order to communicate with, verify, authenticate, and provide wireless communications service coverage to one or more UE that request to join and/or are connected to a network.

An “access point” may refer to hardware, software, devices, or other components at a base station, cell site, and/or cell tower having an antenna, an antenna array, a radio, a transceiver, and/or a controller. Generally, an access point may communicate directly with user equipment according to one or more access technologies (e.g., 3G, 4G, LTE, 5G, mMIMO) as discussed hereinafter.

The terms “radio,” “controller,” “antenna,” and “antenna array” are used interchangeably to refer to one or more software and hardware components that facilitate sending and receiving wireless radio-frequency signals, for example, based on instructions from a base station. A radio may be used to initiate and generate information that is then sent out through the antenna array, for example, where the radio and antenna array may be connected by one or more physical paths. Generally an antenna array comprises a plurality of individual antenna elements. The antennas discussed herein may be dipole antennas, having a length, for example, of ¼, ½, 1, or 1½ wavelength. The antennas may be monopole, loop, parabolic, traveling-wave, aperture, yagi-uda, conical spiral, helical, conical, radomes, horn, and/or apertures, or any combination thereof. The antennas may be capable of sending and receiving transmission via FD-MIMO, Massive MIMO, 3G, 4G, 5G, and/or 802.11 protocols and techniques.

Additionally, it will be understood that terms such as “first,” “second,” and “third” are used herein for the purposes of clarity in distinguishing between elements or features, but the terms are not used herein to import, imply, or otherwise limit the relevance, importance, quantity, technological functions, sequence, order, and/or operations of any element or feature unless specifically and explicitly stated as such.

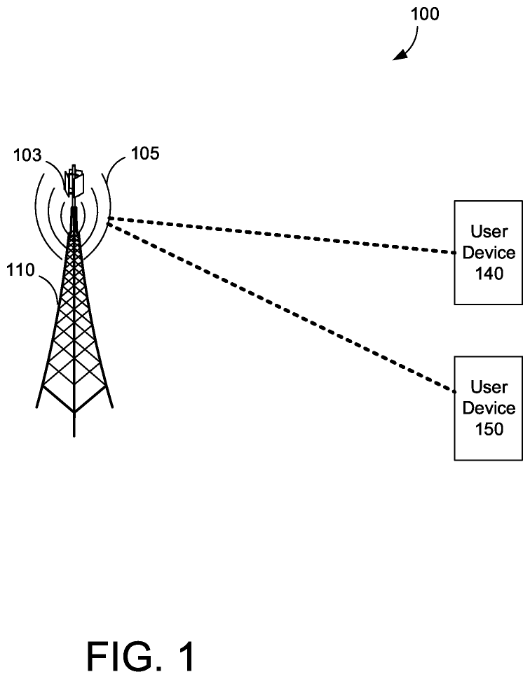

FIG. 1 illustrates an example of a network environment 100 suitable for use in implementing embodiments of the present disclosure. The network environment 100 is but one example of a suitable network environment and is not intended to suggest any limitation as to the scope of use or functionality of the disclosure. Neither should the network environment 100 be interpreted as having any dependency or requirement relating to any one or combination of components illustrated.

The network environment 100 provides service to one or more devices 140 and 150. In some embodiments, the network environment 100 may include a telecom network (e.g., a telecommunication network such as, but not limited to, a wireless telecommunication network), or portion thereof. The network environment 100 may include one or more devices and components, such as base stations, servers (e.g., provisioning server(s), presence server(s), conversation server(s), video sharing server(s), message storage server(s), switches, relays, amplifiers, databases, nodes, etc.) which are not shown so as to not confuse other aspects of the present disclosure. Those devices and components may provide connectivity in a variety of implementations. In addition, the network environment 100 may be utilized in a variety of manners, such as a single network, multiple networks, or as a network of networks, but, ultimately, is shown as simplified as possible to avoid the risk of confusing other aspects of the present disclosure.

The telecom network included in the network environment 100 may include or otherwise may be accessible through a cell site (e.g., the cell site 110). The cell site may include one or more antennas, base transmitter stations, radios, transmitter/receivers, digital signal processors, control electronics, GPS equipment, power cabinets or power supply, base stations, charging stations, etc. such that the cell site may provide a communication link between one or more user devices (e.g., one or more provider devices and/or receiver devices such as the devices 140 and 150) and other components, systems, equipment, and/or devices of the network environment 100. The base station and/or a computing device (e.g., whether local or remote) associated with the base station may manage or otherwise control the operations of components of the cell site.

In some embodiments, the cell site may be operable in a non-stand alone (NSA) mode. In the non-stand alone mode the network environment 100 may take the form of, for example, an E-UTRAN New Radio-Dual Connectivity (EN-DC) network. In an EN-DC network, a provider device and/or a receiver device may connect to or otherwise access a 4G, LTE, 5G, or any other suitable network simultaneously. In the stand-alone mode, the telecom network may take the form of a 5G, 6G, or any other suitable network.

In some embodiments, the network environment 100 may include one or more nodes communicatively coupled to the user devices 140 and 150 such that the node(s) may transmit to and receive requests and/or data from the user device(s). The one or more nodes may include a Next Generation Node B (e.g., gNodeB or gNB) or any other suitable node. The one or more nodes may correspond to one or more frequency bands within which the provider device(s) and/or the receiver device(s) may connect to the network environment such as, but not limited to, a telecommunication network or a portion thereof.

In some embodiments, the node(s) may be included within the cell site (e.g., the cell site 110), external to the cell site, or otherwise communicatively coupled to the cell site. The node(s) may allocate radio frequency, or a portion thereof, to user device(s).

In some embodiments, the user devices 140 and/or 150 may take the form of a wireless or mobile device capable of communication via the network environment 100. For example, the user device 140 may take the form of a mobile device capable of communication via a telecom network such as, but not limited to, a wireless telecommunication network. In this regard, the provider device(s) and/or the receiver device(s) may be any computing device that communicates by way of a network, for example, a 4G, LTE, WiMAX, Wi-Fi, 5G, 6G, or any other type of network.

In some embodiments, the network environment 100 may connect subscribers (e.g., current subscribers and/or potential subscribers) to a service provider or a plurality of service providers. Alternatively or additionally, the network environment 100 may be associated with a specific telecommunication provider or a plurality of telecommunication providers that provide services (e.g. 5G, 6G, voice, location, data, etc.) to one or more user devices. For example, the user device 140 and/or 150 may be subscribers to a telecommunication service provider, in which the devices are registered or subscribed to receive voice and data services (e.g., receive SMS, RCS, MMS messages, etc.) over the network environment 100. The network environment 100 may include any communication network providing voice and/or data service(s), such as, for example, a Wi-Fi network, 4G network (LTE, WiMAX, HSDPA), 5G network, or 6G network.

Having described the network environment 100 and components operating therein, it will be understood by those of ordinary skill in the art that the network environment 100 is but one example of a suitable network and is not intended to limit the scope of use or functionality of aspects described herein. Similarly, the network environment 100 should not be interpreted as imputing any dependency and/or any requirements with regard to each component and combination(s) of components illustrated in FIG. 1. It will be appreciated by those of ordinary skill in the art that the number, interactions, and physical location of components illustrated in FIG. 1 are examples, as other methods, hardware, software, components, and devices for establishing one or more communication links between the various components may be utilized in implementations of the present invention. It will be understood to those of ordinary skill in the art that the components may be connected in various manners, hardwired or wireless, and may use intermediary components that have been omitted or not included in FIG. 1 for simplicity's sake. As such, the absence of components from FIG. 1 should not be interpreted as limiting the present invention to exclude additional components and combination(s) of components. Moreover, though components may be represented as singular components or may be represented in a particular quantity in FIG. 1, it will be appreciated that some aspects may include a plurality of devices and/or components such that FIG. 1 should not be considered as limiting the quantity of any device and/or component.

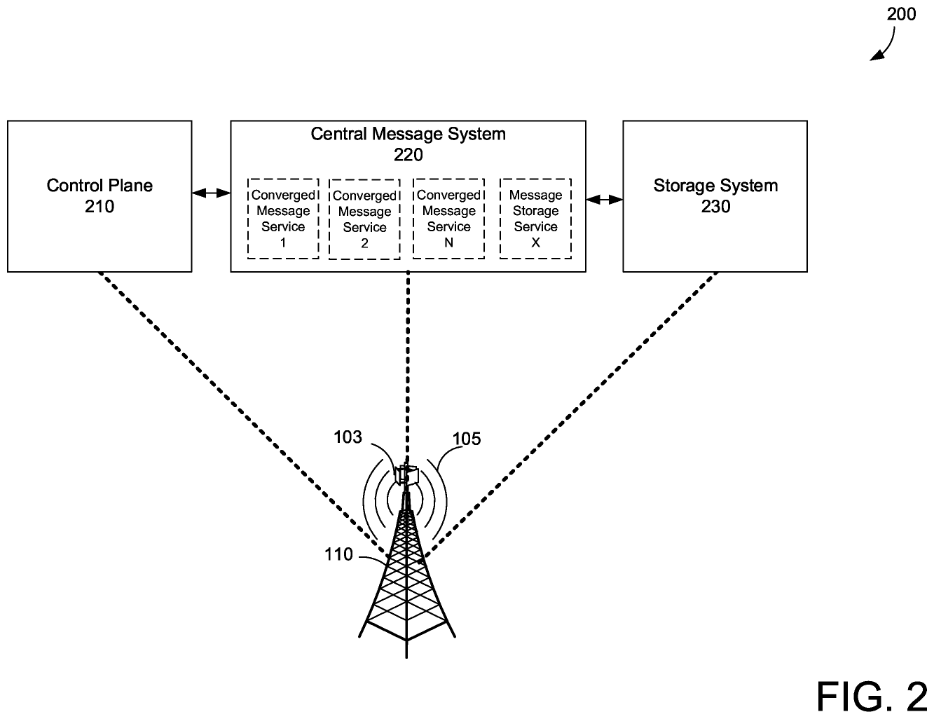

FIG. 2 is a diagram of the network environment 200 (e.g., a telecommunication environment such as, but not limited to, a wireless telecommunication environment) according to an example embodiment. In the present embodiment, the network environment 200 includes the cell site 110, control plane 210, central message system 220, and storage system 230. The central message system may be communicatively coupled to the control plane, storage system, or any other suitable system. Although some of the components in the network environment 200 are depicted as single components (e.g., a single storage system, cell site, etc.), in some embodiments, the network environment 200 may include a plurality of such components.

In some embodiments, the central message system (e.g., the central message system 220) may provide, via one or more converged message services, one or more first messages. The term “central message system” may be used herein to refer to a converged system of central message services (e.g., microservice(s) such as the converged message service 1, 2, . . . N) that includes one or more containers, pods (e.g., a set of running containers, a set of containers in a cluster, etc.), and/or service nodes. The central message system implements telecom message application(s) and/or features that provide or otherwise facilitate message delivery (e.g., a flow of message delivery).

In some embodiments, the one or more converged message services may perform a telecom call operation. For example, the converged message service(s) (e.g., a microservice) may perform a telecom call operation such as, but not limited to, a call service request, call setup (e.g., the creation of a session and/or selection of a session), call service alert, call service connect (e.g., a direct transfer) or disconnect, roaming (e.g., send routing information), etc. Alternatively or additionally, the one or more converged message services may perform a telecom message call operation. For example, the converged message service(s) (e.g., a microservice) may generate a telecom message call operation such as, but not limited to, a short message service (SMS), multi-media service (MMS), rich communication service (RCS), and/or voicemail call flows. In some embodiments, the one or more converged message services may be communicatively coupled to a remote procedure call. In this regard, the converged message service(s) may be communicatively coupled to one or more secondary microservices. For example, a converged message service may be communicatively coupled to a remote procedure call protocol to communicate with other converged message service(s) (e.g. a microservice such as gRPC (gRemote Procedure Call).

The central message system 220 may receive one or more secondary messages responsive to, or otherwise based on, the one or more first messages. The first message(s) and the secondary message(s) may correspond to a SMS, MMS, and/or RCS. The first message(s) and/or the secondary message(s) may be received in real-time or near real-time. Advantageously, the central message system provides a converged service system that reduces the length of message delivery time and simplifies delivery.

The one or more converged message services (e.g., microservice(s) such as converged message service 1, 2, . . . N) may be communicatively coupled to at least one external node. In this regard, the converged message service(s) may be programmed as an API interface or function to support communication from, for example, a message center to one or more external nodes.

In some examples, the converged message service(s) 1, 2, . . . N may correspond to one or more protocol layers. For example, a microservice may be programmed as a protocol layer such as, but not limited to, HTTP (Hypertext Transfer Protocol), SMPP (Short Message Peer-to-Peer), SMTP (Simple Mail Transfer Protocol), SIP (Session Initiation Protocol), REST (Representational Transfer Protocol), UDP (User Datagram Protocol), Diameter Protocol, etc.

In some embodiments, the central message system 220 may include a message storage service (e.g., the message storage service X). The message storage service may store at least one of the first messages or the secondary messages. In some examples, the message storage service may store one or more components corresponding to a message (e.g., a first message, secondary message, etc.). For example, the microservice may be programmed to store components that correspond to the message such as, but not limited to, the message metadata, message text, and/or binary object. The message metadata may be stored (e.g., saved) for various message types. In some embodiments, the message storage service may forward at least one of the one or more first messages or the one or more secondary messages. Advantageously, the storage and/or forward of a message and/or components that correspond to the message results in a single copy of the message eliminating the need for multiple copies of the message.

In some embodiments, the converged message service(s) correspond to one or more protocol layers. For example, the converged message service (e.g., the microservice) may be programmed as a protocol layer used for delivering and archiving message objects into database storage. Advantageously, programming the converged message service(s) as a protocol layer is technology agnostic such that various protocol layers may be utilized regardless of which technology (e.g. RCS, MMS, SMS, etc.) is needed and/or active. In further embodiments, the converged message service 1, 2, and/or N may be operable as a push notification service to support the message storage service X. Alternatively or additionally, the converged message service may be operable as an authentication service and/or an authorization service.

In some embodiments, the user device (e.g., the user device 140) may generate a message interface. The message interface may output or otherwise display the message(s) on the user device (e.g., the user device 140 and/or 150). A user of the user device may select, press, or tap the message(s). The message interface may be communicatively coupled to and/or operable via one or more APIs. The APIs may provide or otherwise transmit the message(s) between the central message system 220, storage system 230, and/or any other system, component, or circuitry of the telecommunications network (e.g., the telecommunication network 200).

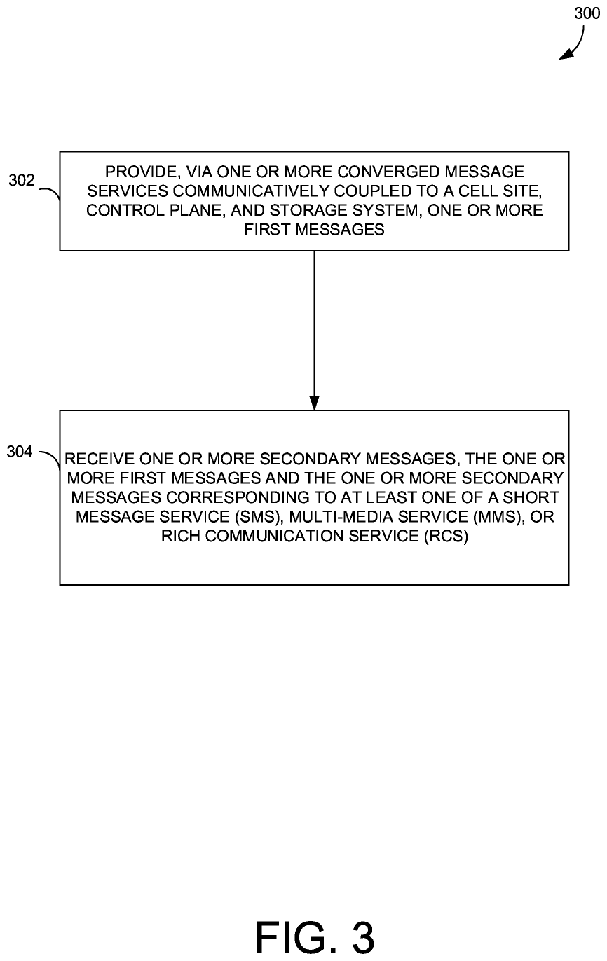

FIG. 3 depicts a flow diagram of an exemplary method 300 for providing converged message services corresponding to one or more messages via a telecommunication network, in accordance with implementations of the present disclosure. Initially at block 302 one or more first messages are provided by one or more converged message services. The converged message service(s) may be included in a central message system (e.g., a converged system that includes one or more containers and/or pods). The converged message service(s) may perform a telecom call operation (e.g., a call service connect (e.g., a direct transfer) or disconnect) and/or a telecom message call operation (e.g., a multi-media service (MMS)). At block 304, one or more secondary messages are received based on the one or more first messages. The first message(s) and the secondary message(s) may correspond to a SMS, MMS, and/or RCS that may be received in real-time or near real-time.

Referring to FIG. 4, a block diagram of an example of a computing device 400 suitable for use in implementations of the technology described herein is provided. In particular, the exemplary computer environment is shown and designated generally as computing device 400. Computing device 400 is but one example of a suitable computing environment and is not intended to suggest any limitation as to the scope of use or functionality of the invention. Neither should computing device 400 be interpreted as having any dependency or requirement relating to any one or combination of components illustrated. In aspects, the computing device 400 may be a base station. In another embodiment, the computing device 400 may be UE capable of two-way wireless communications with an access point. Some non-limiting examples of the computing device 400 include a base station, a controller at a base station, a backhaul server, a personal computer, a cell phone, current UE, legacy UE, a tablet, a pager, a personal electronic device, a wearable electronic device, an activity tracker, a laptop, and the like.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

As shown in FIG. 4, computing device 400 includes a bus 402 that directly or indirectly couples various components together. The bus 402 may directly or indirectly one or more of memory 404, processor(s) 406, presentation component(s) 408 (if applicable), radio(s) 410, input/output (I/O) port(s) 412, input/output (I/O) component(s) 414, power supply 416, and/or transmitter(s) 418. Although the components of FIG. 4 are shown with lines for the sake of clarity, in reality, delineating various components is not so clear, and metaphorically, the lines would more accurately be grey and fuzzy. For example, one may consider a presentation component(s) 408 such as a display device to be one of I/O components 414. Also, the processor(s) 406 may include memory 404, in another example. The present disclosure hereof recognizes that such is the nature of the art, and reiterates that FIG. 4 is merely illustrative of an example of a computing device 400 that may be used in connection with one or more implementations of the present disclosure. Distinction is not made between such categories as “workstation,” “server,” “laptop,” “handheld device,” etc., as all are contemplated within the scope of the present disclosure and refer to “computer” or “computing device.”

Memory 404 may take the form of memory components described herein. Thus, further elaboration will not be provided here, but it should be noted that memory 404 may include any type of tangible medium that is capable of storing information, such as a database or data store. A database or data store may be any collection of records, files, or information encoded as electronic data and stored in memory 404, for example. In one embodiment, memory 404 may include a set of embodied computer-readable and executable instructions that, when executed, facilitate various functions or elements disclosed herein. These embodied instructions will variously be referred to as “instructions” or an “application” for short.

Processor(s) 406 may be multiple processors that receive instructions and process them accordingly. Presentation component(s) 408, if available, may include a display device, an audio device such as a speaker, and/or other components that may present information through visual (e.g., a display, a screen, a lamp (LED), a graphical user interface (GUI), and/or even lighted keyboards), auditory, and/or other tactile or sensory cues.

Radio(s) 410 represents one or more radios that facilitate communication with a wireless telecommunication network. For example, radio(s) 410 may be connected to one or more antenna elements through a physical path. Illustrative wireless telecommunications technologies include CDMA, GPRS, TDMA, GSM, and the like. Radio(s) 410 might additionally or alternatively facilitate other types of wireless communications including Wi-Fi, WiMAX, 3G, 4G, LTE, mMIMO, 5G, 6G, NR, VoLTE, and/or other VoIP communications. As can be appreciated, in various embodiments, radio(s) 410 may be configured to concurrently support multiple technologies, as previously discussed herein. As such, each of many radio(s) 410 may be used to separately control portions of an antenna array, for example, where at least one portion utilizes a distinct technology relative to another portion in the same antenna array or at the same base station or cell site. A wireless telecommunication network might include an array of devices, which are not shown so as to not obscure more relevant aspects of the invention. Components such as a base station, a communications tower, or even access points (as well as other components) can provide wireless connectivity in some embodiments.

The input/output (I/O) ports 412 may take a variety of forms. Exemplary I/O ports 412 may include a USB jack, a stereo jack, an infrared port, a firewire port, other proprietary communications ports, and the like. Input/output (I/O) components 414 may comprise keyboards, microphones, speakers, touchscreens, and/or any other item usable to directly or indirectly input data into the computing device 400.

Power supply 416 may include batteries, fuel cells, and/or any other component that may act as a power source to supply power to the computing device 400 or to other network components, including through one or more electrical connections or couplings. Power supply 416 may be configured to selectively supply power to different components independently and/or concurrently.

Finally, regarding FIGS. 1 through 4, it will be understood by those of ordinary skill in the art that the environment(s), system(s), and/or methods(s) depicted are not intended to limit the scope of use or functionality of the present embodiments. Similarly, the environment(s), system(s), and/or methods(s) should not be interpreted as imputing any dependency and/or any requirements with regard to each component, each step, and combination(s) of components or step(s) illustrated therein. It will be appreciated by those having ordinary skill in the art that the connections illustrated the figures are contemplated to potentially include methods, hardware, software, and/or other devices for establishing a communications link between the components, devices, systems, and/or entities, as may be utilized in implementation of the present embodiments. As such, the absence of component(s) and/or steps(s) from the figures should be not be interpreted as limiting the present embodiments to exclude additional component(s) and/or combination(s) of components. Moreover, though devices and components in the figures may be represented as singular devices and/or components, it will be appreciated that some embodiments can include a plurality of devices and/or components such that the figures should not be considered as limiting the number of devices and/or components.

It is noted that aspects of the present invention are described herein with reference to block diagrams and flowchart illustrations. However, it should be understood that each block of the block diagrams and/or flowchart illustrations may be implemented in the form of a computer program product, an entirely hardware embodiment, a combination of hardware and computer program products, and/or apparatus, systems, computing devices/entities, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

Additionally, as should be appreciated, various embodiments of the present disclosure described herein can also be implemented as methods, apparatus, systems, computing devices/entities, computing entities, and/or the like. As such, embodiments of the present disclosure can take the form of an apparatus, system, computing device, computing entity, and/or the like executing instructions stored on a computer-readable storage medium to perform certain steps or operations. However, embodiments of the present disclosure can also take the form of an entirely hardware embodiment performing certain steps or operations.

Many different arrangements of the various components depicted, as well as components not shown, are possible without departing from the scope of the claims below. Embodiments of our technology have been described with the intent to be illustrative rather than restrictive. Alternative embodiments will become apparent to readers of this disclosure after and because of reading it. Alternative means of implementing the aforementioned may be completed without departing from the scope of the claims below. Certain features and sub-combinations are of utility and may be employed without reference to other features and sub-combinations and are contemplated within the scope of the claims.

The invention claimed is:

1. A system for providing converged message services corresponding to one or more messages via a telecommunication network, the system comprising:
a cell site;
a storage system;
a control plane; and
a central message system comprising one or more converged message services communicatively coupled to the cell site, the control plane, and the storage system, the central message system to:
provide, via the one or more converged message services based on a set of containers in a cluster, one or more first messages; and
receive one or more secondary messages, the one or more first messages and the one or more secondary messages corresponding to at least one of a short message service (SMS), multi-media service (MMS), or rich communication service (RCS).

2. The system of claim 1, wherein the one or more converged message services perform a telecom call operation, and wherein the telecom call operation comprises at least one of a call service request, call setup, call service alert, call service connect, call service disconnect, or roaming.

3. The system of claim 1, wherein the one or more converged message services perform a telecom message call operation, and wherein the telecom message call operation comprises at least one of the SMS, MMS, or RCS.

4. The system of claim 1, wherein the central message system comprises a message storage service.

5. The system of claim 4, wherein the message storage service stores at least one first message or secondary message, and wherein the message storage service forwards the at least one first message or secondary message.

6. The system of claim 1, wherein the one or more converged message services are communicatively coupled to at least one external node.

7. The system of claim 1, wherein the one or more converged message services correspond to one or more protocol layers.

8. The system of claim 1, wherein the one or more converged message services are communicatively coupled to a remote procedure call, and wherein the one or more converged message services are communicatively coupled to one or more secondary microservices.

9. Computer-readable storage media having computer-executable instructions embodied thereon that, when executed by one or more processors, cause the one or more processors to:
provide, via a central message system comprising a message storage service, one or more first messages, wherein the message storage service stores the one or more first messages; and
based on the one or more first messages, receive one or more secondary messages, the one or more first messages and the one or more secondary messages corresponding to at least one of a short message service (SMS), multi-media service (MMS), or rich communication service (RCS).

10. The computer-readable storage media of claim 9, wherein the message storage service stores the one or more secondary messages.

11. The computer-readable storage media of claim 9, wherein the message storage service forwards at least one of the one or more first messages or the one or more secondary messages.

12. The computer-readable storage media of claim 9, wherein the central message system is to perform a telecom call operation, and wherein the telecom call operation comprises at least one of a call service request, call setup, call service alert, call service connect, call service disconnect, or roaming.

13. The computer-readable storage media of claim 9, wherein the central message system is to perform a telecom message call operation.

14. A method for providing converged message services corresponding to one or more messages via a telecommunication network, the method comprising:
providing, via one or more converged message services communicatively coupled to a cell site, control plane, and storage system, one or more first messages; and
receiving one or more secondary messages, the one or more first messages and the one or more secondary messages corresponding to at least one of a short message service (SMS), multi-media service (MMS), or rich communication service (RCS).

15. The method of claim 14, wherein a central message system comprises a message storage service and the one or more converged message services.

16. The method of claim 15, wherein the message storage service stores at least one first message or secondary message, and wherein the message storage service forwards the at least one first message or secondary message.

17. The method of claim 14, wherein the one or more converged message services are communicatively coupled to at least one external node.

18. The method of claim 14, wherein the one or more converged message services perform a telecom call operation.

19. The method of claim 14, wherein the one or more converged message services perform a telecom message call operation, and wherein the telecom message call operation comprises at least one of the SMS, MMS, or RCS.

20. The method of claim 14, wherein a user device is communicatively coupled to at least one of the central message system, a 4G network, E-UTRAN New Radio-Dual Connectivity (EN-DC) network, 5G network, 6G network, or Wi-Fi network.
